(19) United States
(12) Patent Application Publication
(10) Pub. No.: US 2018/0229745 A1
(43) Pub. Date: Aug. 16, 2018

(54) HAND TRUCKS

(71) Applicant: Magline, Inc., Standish, MI (US)

(72) Inventors: Brian Brewer, West Branch, MI (US); Donald Dobler, Alger, MI (US); Ian Michael Cobb, Wixom, MI (US); Grey Burchfield Parker, West Bloomfield, MI (US)

(73) Assignee: Magline, Inc., Standish, MI (US)

(21) Appl. No.: 15/895,394

(22) Filed: Feb. 13, 2018

Related U.S. Application Data
(60) Provisional application No. 62/458,141, filed on Feb. 13, 2017.

(51) Int. Cl. B62B 1/12; B62B 5/02; B62B 5/06; B62B 5/04

(52) U.S. Cl. CPC B62B 1/12; B62B 5/02; B62B 5/0457; B62B 5/0452; B62B 5/064

(57) ABSTRACT

A hand truck having improvements made to simplify and make more ergonomically use of a hand truck by an operator. The hand truck provided having adjustable handles and a bottom portion having adjustable stair climbers with improved feature and an improved wheel and brake assembly have an axle-less wheel assembly and an improved caliper mounting system. These features are discussed in detail in the forgoing.

### CROSS REFERENCE TO RELATED APPLICATIONS

The application claims priority and benefit to U.S. provisional application Ser. No. 62/458,141 filed on Feb. 13, 2017.

### TECHNICAL FIELD

The present specification generally relates to hand trucks and, more specifically, hand trucks with improved use features.

### BACKGROUND

Various hand trucks have been used to transport goods from various modes of transportation (e.g., vans, trucks, boats, trains, etc.) and in and among buildings and the like. Such trucks have a load carrying surface and one or more wheels, and may be manually operated or driven at least in part by a motor or other device. The ease of use of modern hand trucks make the hand truck an ideal tool for transporting heavy objects and has led to the widespread use of hand trucks.

This wide utilization of hand trucks has resulted in increased research and development in the design of the modern hand truck. Currently known hand trucks lack adjustability of handles and other functional portions of the hand truck. Specifically, while stair climbers are known to be provided on hand trucks, adjustability of stair climbers is lacking in the art. Stair climbers are used to assist the user of the hand truck in navigating stairs. Allowing adjustability of the stair climbers leads to increased user function when using stairs with a hand truck.

Furthermore, it is always desirable to reduce cost and assembly time while improving functionality of the hand truck.

Accordingly, a need exists for an improved hand truck providing adjustable features with improved functionality while simultaneously reducing both cost and production time. Similarly, there exists a need for an improved hand truck brake system.

### SUMMARY

The hand truck of the present application includes improvements made to simplify and make more ergonomically use of a hand truck by an operator. The hand truck provided includes adjustable handles and a bottom portion having adjustable stair climbers with improved feature and an improved wheel and brake assembly having an axle-less wheel assembly and an improved caliper mounting system. These features are discussed in detail in the forgoing.

A vehicle having a frame wherein the vehicle includes a brake system, the brake system having a caliper and a corresponding disc brake and a bracket connected to the frame, the bracket configured to support the caliper, the caliper connected to the bracket so as to allow the caliper to float with respect to the bracket and the disc brake.

The vehicle includes a fastener is provided connecting the caliper to the bracket so as to allow the caliper to float with respect to the bracket and the disc brake. In some embodiments, the caliper is connected to the bracket by means of at least one washer and a clevis pin wherein the washer and the clevis pin make up the fastener. In other embodiments the caliper is connected to the bracket by means of at least one washer, a cotter pin and a clevis pin wherein the washer, the cotter pin and the clevis pin make up the fastener. In even further embodiments, the fastener is any bolt, shaft, screw, connector . . . etc. or any other suitable fastener allowing the caliper to float with respect to the bracket and the brake disc. In some embodiments, the vehicle is a hand truck having a plurality of wheels, the hand truck utilizing a corresponding hand brake to actuate the brake system. Typically, the brake system is hydraulic but may be other forms of brakes. Further, in alternative embodiments, the caliper configuration as described above is fixed to the bracket or can be altered to be fixed to the bracket.

In another embodiment, a hand truck is provided having at least a pair of wheels connected to a frame where the hand truck configured to move objects with the help of a user, the hand truck includes a stub axle wheel mount, the stub axle wheel mount including a shaft extending away from the frame towards the wheel, the stub axle wheel mount further including a hub providing for indirect connection of the wheel to the frame. In some embodiments, the shaft passes through the disc brake. In other embodiments, the shaft passes through the wheel hub. Further, the shaft may pass through the wheel bracket. In some embodiments, the bolt is secured by means of a cotter pin at the free end of the bolt.

In other embodiments, a hand truck is provided including a frame, the frame having a generally pair of side rails, a handle connected to the side rails by means of an adjustable bracket where the bracket having a connection portion connectible to the side rails, the handle movable in a generally vertical direction so as to meet the height requirements of the operator of the hand truck by means of adjustment of a removable fastener.

In yet another embodiment, a hand truck is provided having a frame, the frame having a generally vertical support, a handle pivotally connected to the generally vertical support thereby allowing the handle to pivot in a generally horizontal direction allowing the handles to flare outwards and inwards.

In an additional embodiment, a hand truck having at least a pair of wheels connected to a frame, the hand truck configured to move objects with the help of a user where the hand truck includes stair climber assembly, the stair climber assembly including at least one stair climber connected to the frame, the at least one stair climber having a face portion configured to contact a stair when in use, the face having a resilient material disposed thereon and/or therein, the stair climber adjustable with respect to the frame. In some embodiments, the resilient material is removable and replaceable from the hand truck. In other embodiments, the assembly includes at least one adjustable arm extending between the frames and the stair climbers thereby providing for an angular adjustment of the stair climbers with respect to the ground. In some embodiments, a pair of adjustable arms are provided. In some embodiments, each of the adjustable arms of the pair of adjustable arms are independently adjustable. In yet further embodiments, a plurality of identical brackets form each of the pair of adjustable arms.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of the hand truck with a fixed handle according to one or more embodiments shown and described herein:

FIG. 2 depicts an alternative perspective view of the hand truck with a fixed handle according to one or more embodiments shown and described herein:

FIG. 3 depicts a close up perspective view of the hand truck where the stair climbers are in an adjusted position according to one or more embodiments shown and described herein;

FIG. 3A depicts the adjustable angle of the stair climbers according to one or more embodiments shown and described herein;

FIG. 4 depicts a close up perspective view of the hand truck where one stair climber is upright and the other is adjusted according to one or more embodiments shown and described herein

FIG. 5 depicts a close up perspective view of the adjustment mechanism for the stair climber according to one or more embodiments shown and described herein;

FIG. 6 depicts an alternative close up perspective view of the adjustment mechanism bracket for the stair climber according to one or more embodiments shown and described herein;

FIG. 7 depicts a close up perspective view of the attachment means of the adjustment mechanism for the stair climber according to one or more embodiments shown and described herein;

FIG. 8A depicts a perspective view of the stair climber in a partially slid out position according to one or more embodiments shown and described herein;

FIG. 8B depicts a perspective view of an assembled the stair climber according to one or more embodiments shown and described herein;

FIG. 8C depicts an exploded perspective view of the stair climber according to one or more embodiments shown and described herein;

FIG. 9 depicts a perspective view of the adjustable handle assembly according to one or more embodiments shown and described herein;

FIG. 10 depicts a perspective view of another alternative adjustable handle assembly according to one or more embodiments shown and described herein;

FIG. 11 depicts a perspective view of an alternative non-adjustable handle assembly according to one or more embodiments shown and described herein;

FIG. 12 depicts a close up perspective view of the brake caliper and stub axle configuration according to one or more embodiments shown and described herein;

FIG. 13 depicts a close up rear view of the brake caliper and stub axle configuration according to one or more embodiments shown and described herein;

FIG. 14 depicts a cross-sectional perspective view of the wheel and corresponding hub insert according to one or more embodiments shown and described herein;

FIG. 15 depicts a close up perspective view of the brake calipers according to one or more embodiments shown and described herein;

FIG. 16 depicts a close up perspective view of the brake calipers according to one or more embodiments shown and described herein; and

FIG. 17 depicts an elevational view of the brake calipers according to one or more embodiments shown and described herein.

### DETAILED DESCRIPTION

The vehicle, specifically a hand truck of the present embodiment, includes improvements made to simplify and make more ergonomically use of a hand truck by an operator. The hand truck provided includes adjustable handles and a bottom portion having adjustable stair climbers with improved feature and an improved wheel and brake assembly having an axle-less wheel assembly and an improved caliper mounting system. These features are discussed in detail in the forgoing. Improvements to the vehicle of the present specification can be applied to any vehicle or similar apparatus configured to move goods or people in an either motorized or non-motorized manner.

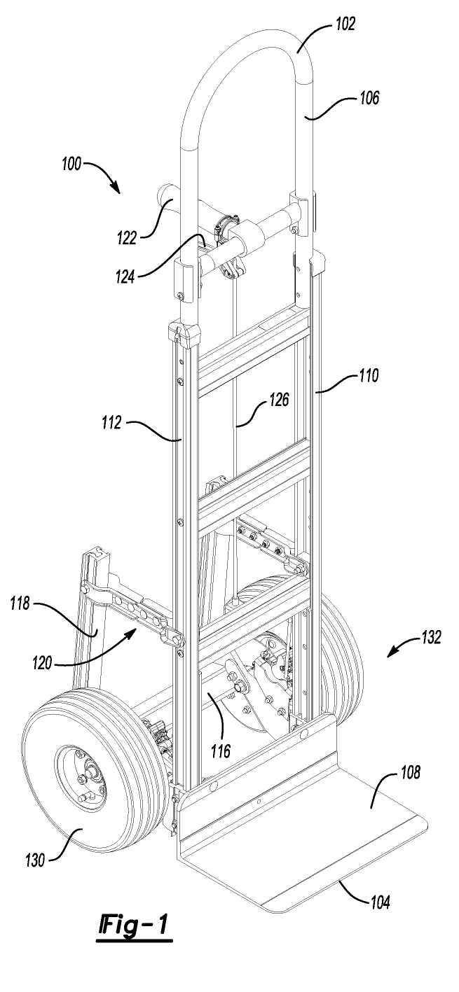

FIG. 1 generally depicts a hand truck having an improved bottom assembly and improved handle adjustability. The hand truck of the present specification includes any combination of a stub axle wheel mount, an improved stair climber assembly, an adjustable handle, an adjustable stair climber, and a hydraulic brake caliper or any element used on a hand truck independently. These components both individually and together yield an improved hand truck assembly as disclosed herein.

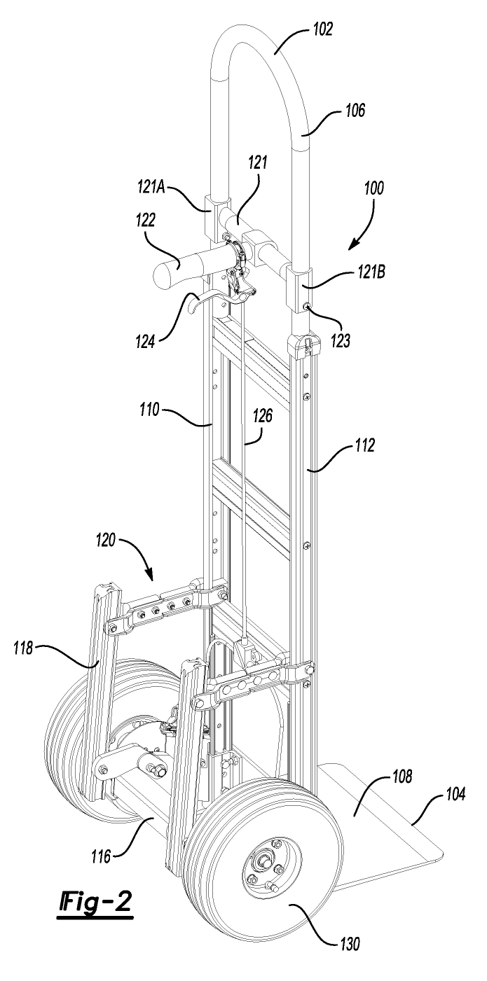

Referring now to FIGS. 1 and 2, a hand truck is provided having an stub axle wheel mount, an improved stair climber assembly, an adjustable stair climber, and an improved brake caliper. The hand truck 100 generally includes an upper end 102 spaced apart from a lower end 104. The upper end 102 includes an upper handle 106 and corresponding handle 122. The lower end includes the lifting surface 108 connected to the frame of the hand truck 100. The frame includes side rails 110, 112 that may extend vertically between the upper end 102 and the lower end 104. A strap may be configured to prevent smaller packages and cargo from falling between the side rails 110, 112. It should be noted that any of the adjustable handle variations provided herein may alternatively be applied to this hand truck 100 as shown in FIGS. 1 and 2, or applied to any other hand truck shown and described herein.

The handle grip 122 is connected at a center bracket between the handle ends. In this embodiment, the handle 122 connects to the bracket 121. The bracket includes connection portions 121A, 121B configured to at least partially extend around the handle 106. The bracket 121 and connection portions 121A, 121B connect by means of a fastener 123.

The frame further includes a plurality of wheels 130. In the present embodiment, two wheels 130 are provided connected directly or indirectly to the frame.

The hand truck 100 includes the entire bottom assembly 132 including various improved features. The bottom assembly 132 generally includes the wheels 130, the stair climbers, the stub axle wheel mounts, the hydraulic brake calipers, and the adjustability means for the stair climbers and is generally located at the bottom of the hand truck including all components of the lower portion of the hand truck 100.

The fixed handle 122 includes the brake lever 124. The brake lever 124 is connected via a hydraulic line 126 to the hydraulic brake and hydraulic brake calipers mounted adjacent to the wheel bracket enabling the brake caliper to straddle the brake disc to the wheels 130.

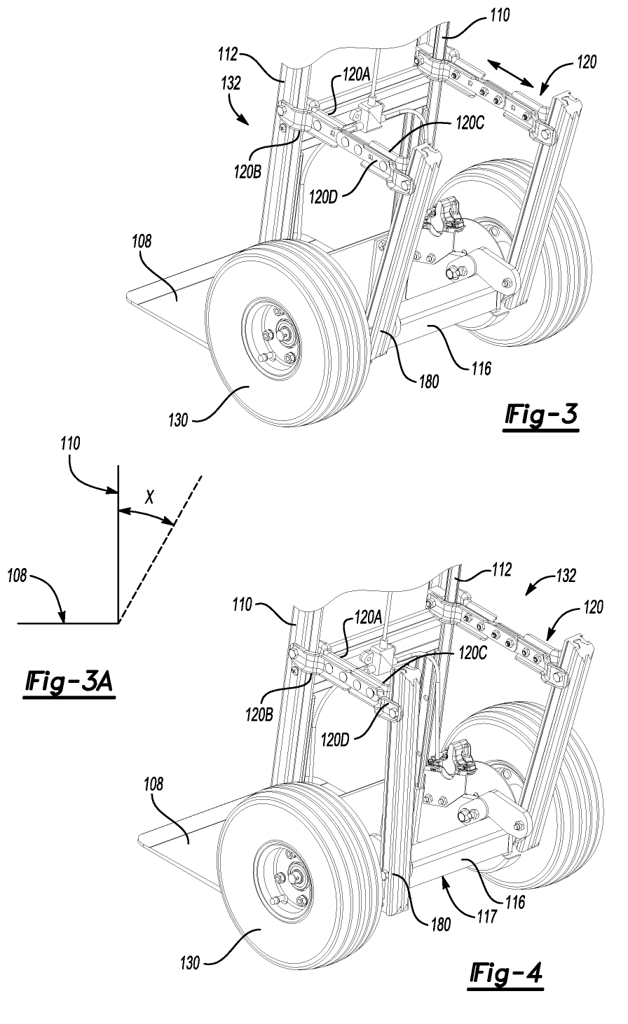

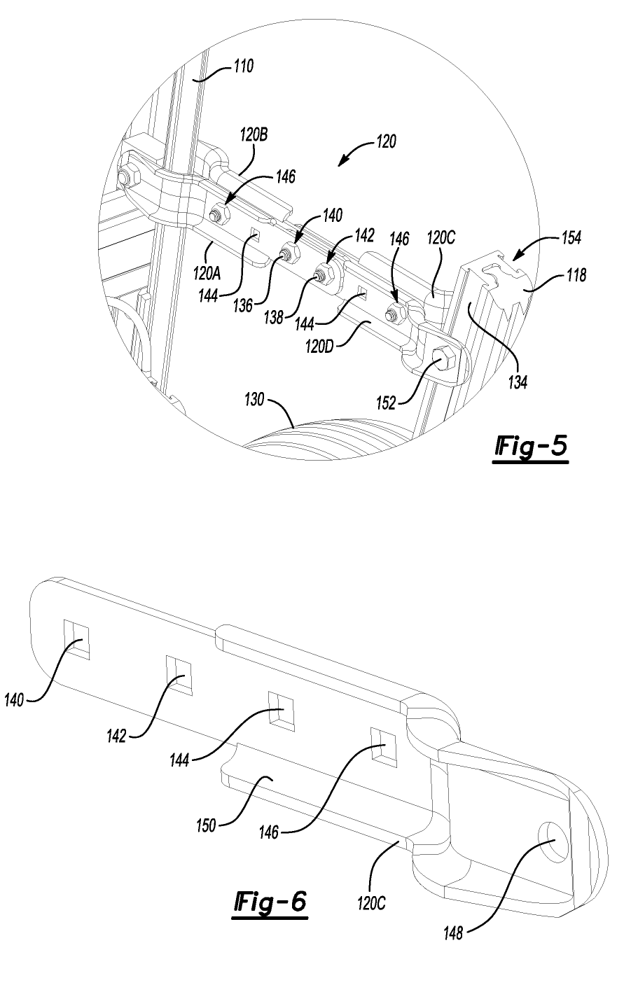

FIGS. 3, 4 and 5 generally depict the bottom assembly 132 of the hand truck 100. The bottom assembly 132 includes the stair climbers 154 adjustably connected using the adjustment mechanism 120 to the frame of the hand truck 100. The adjustment mechanism 120 includes a plurality of identical brackets interconnected to provide for adjustability. FIGS. 5 through 8 further depict the adjustment assembly 120. The adjustment assembly 120 includes brackets 120A. 120B. 120C, 120D. The brackets 120A, 120B, 120C, 120D are interconnected by means of a plurality of bolts and lock nuts 136, 138. In other embodiments, the bolts may be any other suitable fastener configured to connect the brackets together. In even further embodiments stampings, extrusions or castings of the brackets 120A, 120B, 120C, 120D may be used to enable connection and communication between the brackets 120A, 120B, 120C, 120D.

FIGS. 5 and 6 Each of the brackets 120A, 120B, 120C, 120D include a plurality of apertures 140, 142, 144, 146. The brackets 120A, 120B, 120C, 120D may be adjusted with respect to each other and aligned according to the apertures 140, 142, 144, 146 and secured by means of the bolts 136, 138. The brackets 120A, 120B, 120C, 120D are connected to the frame of the hand truck 100 by means of a bolt and further connected to the stair climber 154 by means of a fastener 152. In this embodiment, the fastener 152 is a bolt with a corresponding lock nut. However, the fastener 152 may include any other suitable fastener configured to connect the brackets 120A, 120B, 120C, 120D.

If the user desires to adjust the angle of the stair climber 154 with respect to the frame of the hand truck 100, the user may remove and reposition the bolts 136, 138 through the apertures 140, 142, 144, 146 of each of the brackets 120A, 120B, 120C, 120D. In the present embodiment, eight total brackets are provided wherein four brackets are provided on each side of the bottom assembly 132 of the hand truck 100.

The adjustment assembly 120 allows the user to adjust the angle of the stair climbers 154 with respect to the frame of the hand truck 100. In prior embodiments where stair climbers are adjustable, the stair climbers are only adjustable up to 85 degrees. In the present embodiment, the adjustment assembly 120 is adjustable between angle X which ranges 85-105° with respect to the floor that the hand truck 100 rests upon, away from and with respect to the frame of the hand truck 100 (as shown by FIG. 3a). The larger angle allows the user to more easily maneuver the hand truck 100 when in use.

Furthermore, the symmetrical brackets decrease cost by only requiring only one tooling for manufacturing, the identical brackets are easy to assemble thereby reducing assembly time. In alternative embodiments, the brackets are made using casting, stamping, extrusion . . . etc. achieving the same or similar result of identical brackets and simplicity of assembly/reduced cost.

FIG. 3 illustrates the kick bar 116 of the present embodiment extending generally between the wheels 130. In the present embodiment, the kick bar 116 includes treads or ridges on the underside surface 117 of the kick bar 116. The ridges on the surface 117 further assist in gripping on the user's shoe during use.

During use, a user frequently will put the top side of his or her shoe adjacent to the underside surface 117 of the kick bar 116 to generate leverage when tilting the hand truck 100. Additionally, the user may position the bottom of their shoe on the top side of the kick bar so as to generate additional leverage. Accordingly, ridges may also be provided on the upper surface of the kick bar. The ridges on the surface 117 improve traction between the user's shoe and the kick bar thereby improving performance of the hand truck 100. In alternative embodiments, protrusions, bumps or other elevated surface may be used to improve traction. In even further embodiments, textured surfaces may be alternatively or additionally used to improve traction. Similarly, the top surface may include similar or identical ridges to improve traction between the user's shoe and the kick bar thereby improving performance of the hand truck 100. The ridges on the top surface provide traction for pushing downward to push the hand truck nose under a load.

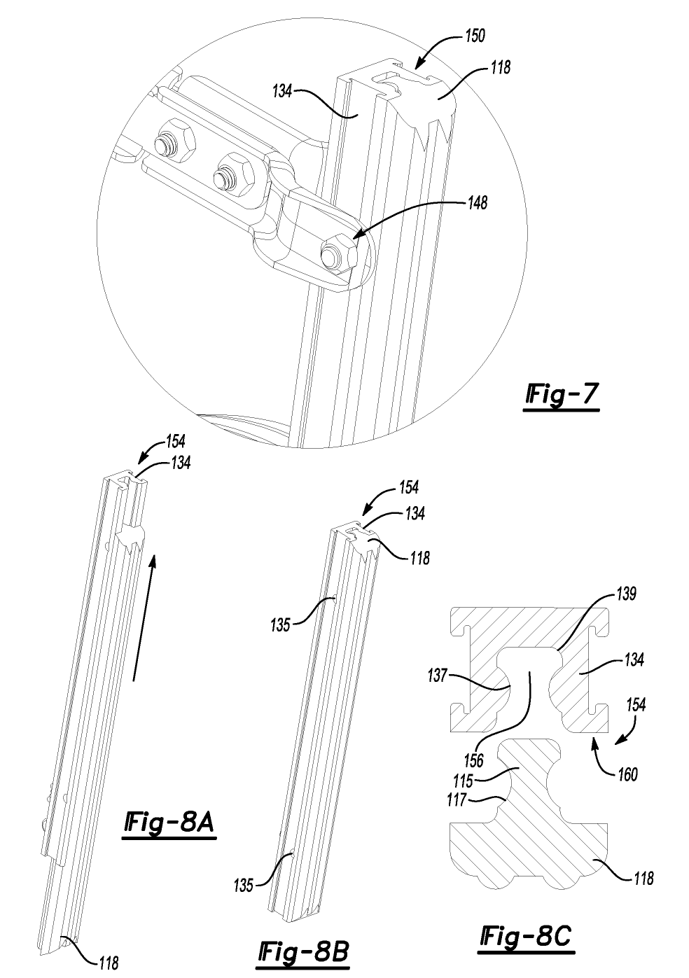

FIGS. 7, 8A, 8B and 8C generally depict the stair climber 154. The stair climber 154 includes an aluminum, or other metal, extrusion 134 connected to a polymer extrusion 118. The two piece assembly is connected together by means of sliding, such as depicted in FIG. 8A. The polymer extrusion 118 is slid into the extrusion 134 and secured into place with fastener 135, such as illustrated in FIG. 8B. In some embodiments, the fastener is a bolt having a corresponding lock nut (148). However, the fastener 135 can be any suitable fastener for securing the pieces together. The metal extrusion 134 includes an open area 156 including structure to correspond with the polymer extrusion 118.

In the present embodiment, the extrusion 134 includes a plurality of protrusions 137 and indentations 139 along the surface which directly correspond with the protrusions 115 and indentions 117 of the polymer extrusion 118. The polymer extrusion 118 is configured to create a secure fit between the extrusion 134 and the polymer extrusion 118. In other embodiments, the portions 118 and 134 are molded or otherwise formed by other means aside from extrusion.

In the present embodiment, the extrusion 134 is made of aluminum. In other embodiments, the extrusion 134 may be made of other suitable metals, polymers, polymer like materials, plastics, or plastic like materials. Similarly, in the present embodiment, the extrusion 118 is made of a polymer. In other embodiments, the extrusion 118 may be made of nylon, plastic, plastic like materials, polymer like materials, or any other suitable material with comparable properties.

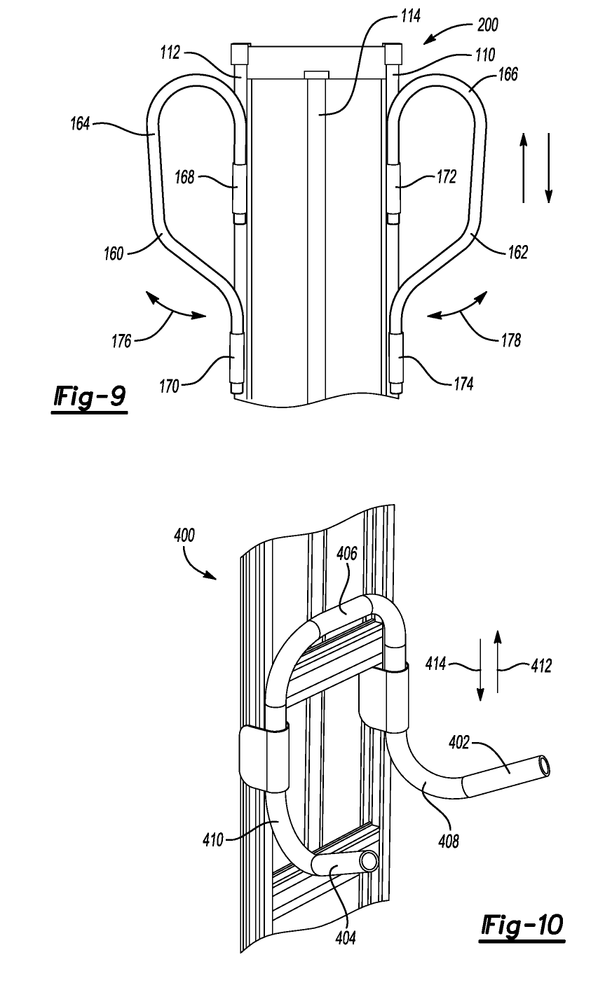

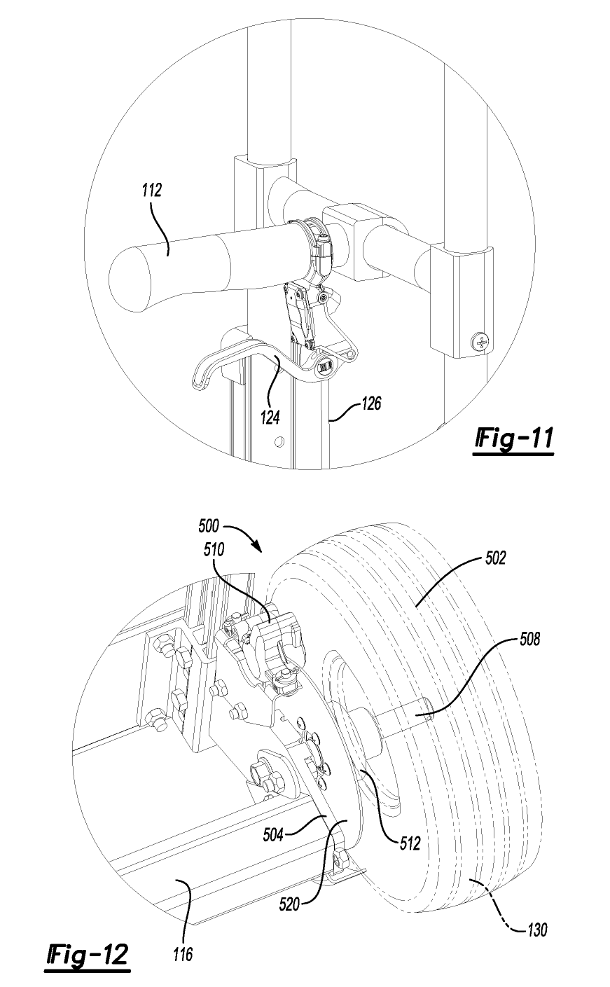

FIGS. 9-10 depict two different embodiments for adjustable handles. In the first embodiment, such as illustrated in FIG. 9, the handle assembly 200 includes a first handle portion and a second handle portion. The first handle portion includes a plurality of bends 160, 164 to form the handle. The handle connects at connection point 168. The handle further connects at connection point 170. The connection points 168, 170 allow the handle to move in both vertical and horizontal directions, as illustrated by directional arrow 176. The handle is configured to rotate within connection points 168, 170 to adjust to a desired position by the user.

Similarly, the second handle portion includes a plurality of bends 162, 166. The second handle portion includes connection points 172, 174 allowing both vertical and horizontal movement by way of pivoting, as illustrated by directional arrow 178.

Yet another alternative embodiment of the adjustable handle is illustrated in FIG. 10. The adjustable handle 40X) includes a one piece assembly having end handle portions 402, 404. The one piece assembly includes a plurality of bends 408, 410. The adjustable handle 400 further includes an upper portion 406 which may also be used as a gripping member. In this embodiment, only vertical adjustment is provided. The one piece assembly does not provide for any horizontal or pivotable movement.

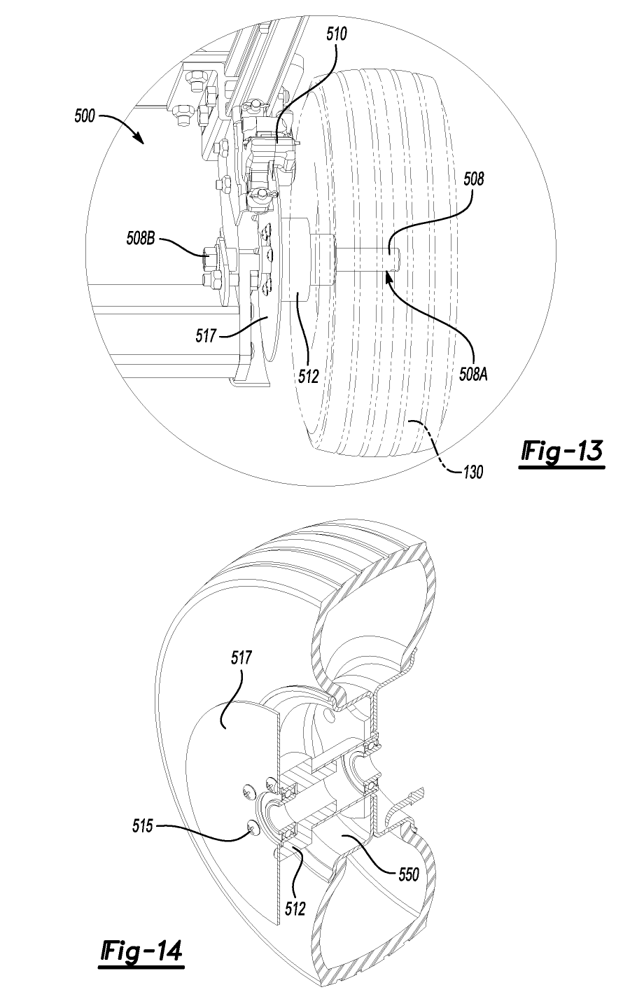

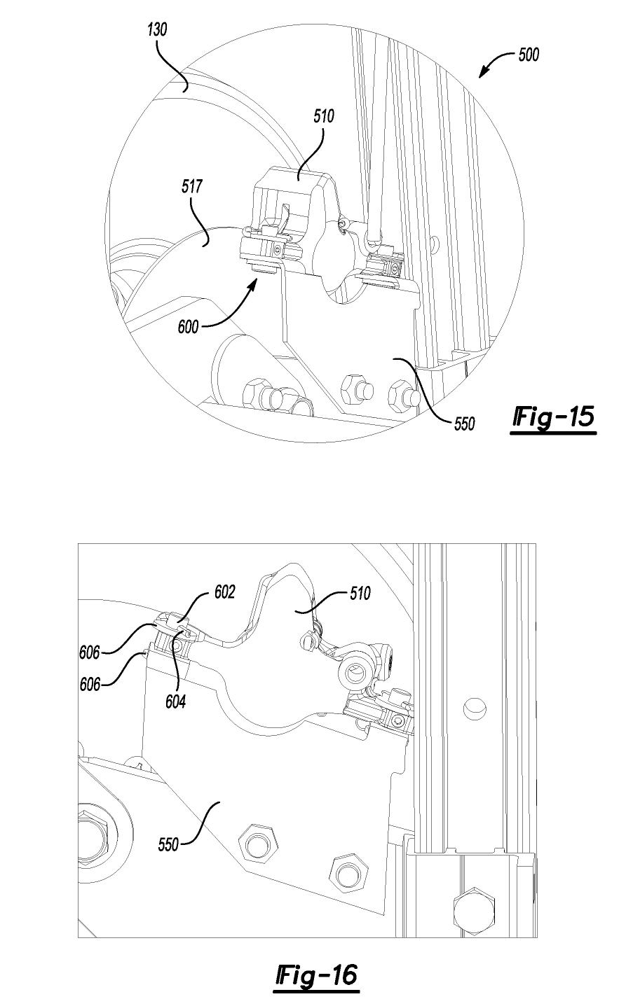

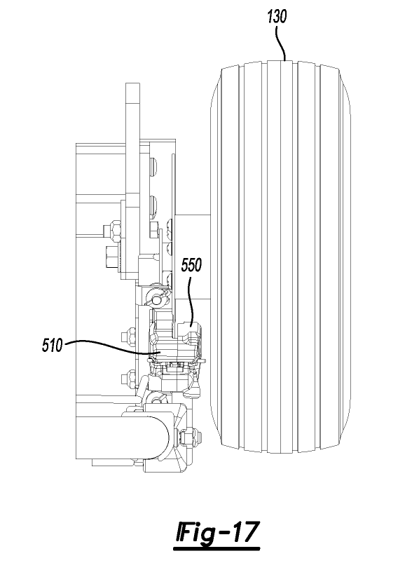

FIGS. 12 through 17 illustrate both the axle-less wheel mount and the hydraulic brake system of the present embodiment. The stub axle wheel mount 500 includes a stub axle 508 extending directly from the hand truck to the wheel 130. The stub axle 508 may alternatively be a standard bolt, shaft, or machined component, not necessarily a shoulder bolt. Each wheel 130 is attached to the hand truck via the stub axle 508 through the brake disc insert 512. The stub axle head 508B is captured against the wheel bracket. The stub axle 508 passes through the wheel bracket, the brake disc 517, and the wheel 130. The stub axle 508 is secured with a cotter pin 508A. In other embodiments, the stub axle 508 is secured with a screw, bolt or other similar fastener. The configuration as described herein prevents deflection of any other misalignment from affecting the brake system thereby providing for an improved and more accurate brake system.

In the present embodiment, such as shown in FIG. 12, the brake disc 517 is connected to a brake disc insert 512. The brake disc insert 512 is pressed into or otherwise affixed to the existing wheel hub 550. In other embodiments, the brake disc insert is screwed or otherwise fastened to the wheel hub 550. The present configuration allows for mounting of the wheel 130 directly to the assembly. Accordingly, any deflection does not effect the brake system.

In the present embodiment, a hydraulic brake system is provided. A hydraulic brake system includes a caliper 510 connected to a caliper mounting bracket 550. In some embodiments, the caliper 510 is mounted to the caliper mounting bracket 550 by means of a bolt or other fastener. In the present embodiment, the caliper 510 is mounted to the mounting bracket 550 in a floating configuration by a floating assembly 600. The floating assembly 600, the in present embodiment, includes the combination of a clevis pin 602, a cotter pin 604 and at least one washer 606. The configuration of using the clevis pin 602, the cotter pin 604 and at least one washer 606 creates a floating effect of the caliper 510 as mounted to the mounting bracket 550. In this floating configuration, the caliber 510 floats whereby instead of being bolted to the mounting bracket 550, it is fastened with the clevis pin 602, the cotter pin 604 and at least one washer 606 to allow the caliper 510 to move slightly with response to the mounting bracket 550 to account for any misalignment with the disc and the caliper 510.

The caliper 510 is positioned adjacent to the wheel 130. The caliper 510 is further positioned adjacent to and configured to straddle the hub mounted disc brake 517. It should be noted that the floating caliper assembly as provided herein may be used in connection with any axle type system, including traditional axles.

The hydraulic brake system is actuated upon movement of the lever 124. Movement of the lever actuates the hydraulic line 126 (or fluid within the hydraulic line) which communicates the desire to brake to the caliper 510. The caliper 510 is configured to exert a force against the brake disc 517 thereby resulting in a braking action. Similar configuration such as described herein can also be applied to non-hydraulic brake system on non-hand truck configurations.

In a typical embodiment, when the lever 124 is actuated, a push rod exerts a force on a piston in a master cylinder causing fluid from the brake fluid reservoir to flow into a pressure chamber through a compensating port. This results in an increase in pressure of the hydraulic system thereby forcing fluid through the hydraulic lines towards the caliper 510. The caliper 510 then applies a force to the disc brake disc 517 to stop or prevent motion of the disc brake 517. The pressure exerted by the caliper 510 on the disc brake 517 creates a slowing of the rotation of the disc brake 517.

Subsequent release of the lever 124 allows the master cylinder assembly to return to the master piston back into a first and rest position. This action first relieves the hydraulic pressure on the caliper and then applies suction to the brake piston in the caliper assembly thereby moving it back into its first position and allowing subsequent rotation of the brake disc 517. In alternative embodiments, a piece of spring steel is provided. The spring steel pushes the calipers back into place when the lever is released.

The components of the above discussed hand trucks are made of metal and various polymers. In other embodiments, the above listed components may be made of any other suitable material such as plastics, plastic-like, polymer like or any other material having the suitable properties enabling proper functionality.

The hand truck 100, and other embodiment disclosed herein, improve adjustability of the handles, adjustability of the stair climber, provide and to an improved stair climber, provide an improved stub axle wheel mount system and an improved braking system. The combination of these elements in the bottom assembly of the hand truck yield a hand truck with improved functionality while also reducing overall cost and assembly time.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle having a frame, the vehicle comprising:
a brake system, the brake system having a caliper and a corresponding disc brake; and
a bracket connected to the frame, the bracket configured to support the caliper, the caliper connected to the bracket so as to allow the caliper to float with respect to the bracket and the disc brake.

2. The vehicle of claim 1 wherein a fastener is provided connecting the caliper to the bracket so as to allow the caliper to float with respect to the bracket and the disc brake.

3. The vehicle of claim 1 wherein the caliper is connected to the bracket by means of at least one washer and a clevis pin.

4. The vehicle of claim 1 wherein the caliper is connected to the bracket by means of at least one washer, a cotter pin and a clevis pin.

5. The vehicle of claim 1 wherein the vehicle is a hand truck having a plurality of wheels, the hand truck utilizing a corresponding hand brake to actuate the brake system.

6. The vehicle of claim 1 wherein the brake system is hydraulic.

7. The vehicle of claim 1 wherein the caliper is alternatively fixed to the bracket.

8. A hand truck having at least a pair of wheels connected to a frame, the hand truck configured to move objects with the help of a user, the hand truck comprising:
a stub axle wheel mount, the stub axle wheel mount including a shaft extending away from the frame towards the wheel, the stub axle wheel mount further including a hub providing for indirect connection of the wheel to the frame.

9. The hand truck of claim 8 wherein the shaft passes through the disc brake.

10. The hand truck of claim 8 wherein the shaft passes through the wheel hub.

11. The hand truck of claim 8 wherein the shaft passes through the wheel bracket.

12. The hand truck of claim 8 wherein the bolt is secured by means of a cotter pin at the free end of the bolt.

13. A hand truck comprising:
a frame, the frame having a generally pair of side rails;
a handle connected to the side rails by means of an adjustable bracket; and
the bracket having a connection portion connectible to the side rails, the handle movable in a generally vertical direction so as to meet the height requirements of the operator of the hand truck by means of adjustment of a removable fastener.

14. A hand truck comprising:
a frame, the frame having a generally vertical support;
a handle pivotally connected to the generally vertical support thereby allowing the handle to pivot in a generally horizontal direction allowing the handles to flare outwards and inwards.

15. A hand truck having at least a pair of wheels connected to a frame, the hand truck configured to move objects with the help of a user, the hand truck comprising:
a stair climber assembly, the stair climber assembly including at least one stair climber connected to the frame, the at least one stair climber having a face portion configured to contact a stair when in use, the face having a resilient material disposed thereon and/or therein, the stair climber adjustable with respect to the frame.

16. The hand truck of claim 15 wherein the resilient material is removable and replaceable from the hand truck.

17. The hand truck of claim 15 wherein the assembly includes at least one adjustable arm extending between the frames and the stair climbers thereby providing for an angular adjustment of the stair climbers with respect to the ground.

18. The hand truck of claim 15 wherein a pair of adjustable arms are provided.

19. The hand truck of claim 18 wherein each of the adjustable arms of the pair of adjustable arms are independently adjustable.

20. The hand truck of claim 15 wherein a plurality of identical brackets form each of the pair of adjustable arms.
